(19) United States
(12) Patent Application Publication
(10) Pub. No.: US 2025/0243016 A1
(43) Pub. Date: Jul. 31, 2025

(54) SYSTEMS AND METHODS INVOLVING OBJECT PROCESSING USING LEVITATION

(71) Applicant: BAADER Food Systems USA, Inc., Kansas City, KS (US)

(72) Inventors: Ryan John FOLTZ, Bucyrus, KS (US); Ryan Wesley O'DELL, Weatherby Lake, MO (US)

(73) Assignee: BAADER Food Systems USA, Inc., Kansas City, KS (US)

(21) Appl. No.: 19/041,903

(22) Filed: Jan. 30, 2025

Related U.S. Application Data
(60) Provisional application No. 63/626,996, filed on Jan. 30, 2024.

(51) Int. Cl. B65G 54/02; H02K 41/03

(52) U.S. Cl. CPC B65G 54/02; H02K 41/031; B65G 2201/0202; B65G 2203/0258

(57) ABSTRACT

A system and method for processing of food parts includes use of carriers for receiving, transporting, and presenting food parts for processing, including trimming. The carriers are moved about reconfigurable worktable under computer control from an infeed location, to a processing location, and to an outfeed location. Operators perform trimming of the food parts into constituent food parts that are transported by the carriers for further processing.

### CROSS-REFERENCE TO RELATED APPLICATIONS

This application claims priority in U.S. Patent Application Ser. No. 63/626,996, filed Jan. 30, 2024, the contents of which are hereby incorporated by reference in its entirety.

### BACKGROUND

Movement of objects through a processing system is influenced by characteristics of the objects, and the processes to be performed on the object. Objects, such as food parts, are processed, in part, based on the type of food part, size, weight, and desired grouping.

Conventional processing methods require a dedicated location for the food parts to enter the processing system and require dedicated infrastructure and hardware to handle and weigh the food parts. Further, the processing methods require specialized hardware designed specifically for the task. As a result, the conventional processing methods involve a complicated arrangement of equipment and work stations, are limited in their adaptability to new equipment or the arrangement of the equipment in an existing food processing facility, and are limited in their placement within existing processing systems. Conventional processing methods and their associated hardware are designed with a specific footprint, for a specific task, and a change in task or footprint requires a new hardware at great expense. In processing situations where the number of constituent food parts are created from a beginning food part, the associated hardware and its arrangement is even more specialized, and such hardware can be used for only the tasks it was designed to accomplish.

### SUMMARY

Processing of food parts includes use of carriers for receiving, transporting, and presenting food parts for trimming into constituent parts. The carriers are moved magnetically about a worktable to allow operators to perform food processing operations on the food parts. The carriers are adapted to determining the weight of the food parts and constituent parts thereon, and are used to move the parts from an infeed location to a processing location and to an outfeed location for further processing.

### BRIEF DESCRIPTION OF THE DRAWINGS

The present disclosed subject matter is described herein with reference to the following drawing figures, with greater emphasis being placed on clarity rather than scale:

FIG. 1 is plan view of a magnetic levitation system according to an aspect of the disclosed subject matter.

FIG. 2 is a plan view of a magnetic levitation system according to an aspect of the disclosed subject matter.

FIG. 3 is a plan view of a magnetic levitation system according to an aspect of the disclosed subject matter.

FIG. 4 is a schematic diagram of an implementation of the disclosed subject matter.

### DETAILED DESCRIPTION

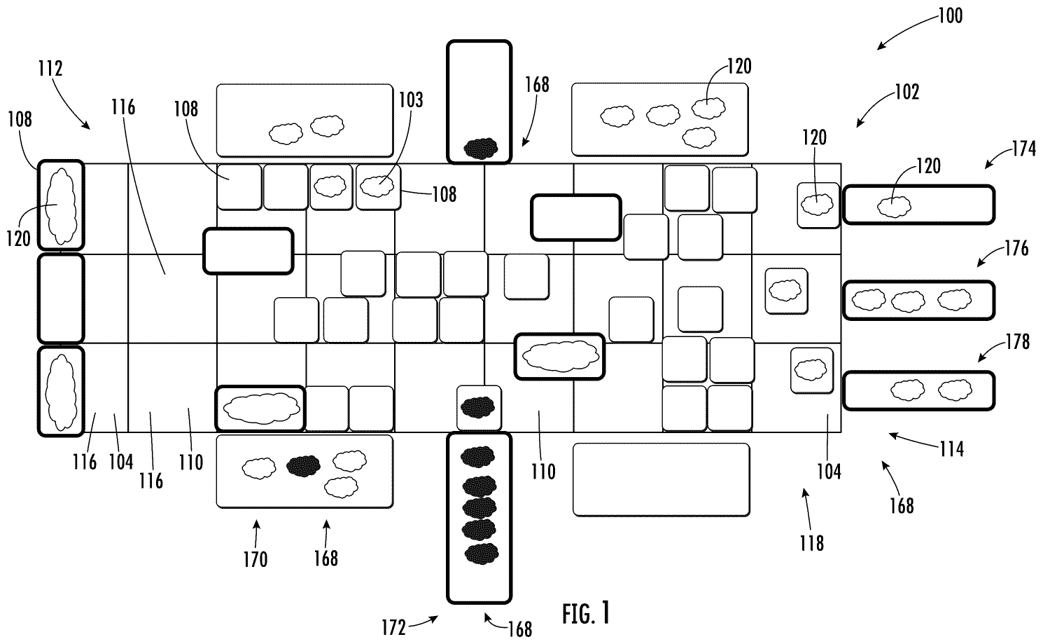

An apparatus, system, and method for item 103 processing using a magnetic levitation system 100 is shown and described in the following detailed description and FIGS. 1-4. The system includes an electromagnetic conveyor system 102 having a plurality of planar motors 106, with a plurality of tiles 104 or carriers 108 independently movable across an array of drive coils 107 or stators. The system moves carriers 108 in a processing operation from a first location 112 to a second location 114 or anywhere about a worktable 118 presenting items 103 on the carriers 108 to processing locations 168 and operators 124 for sorting, batching, and loading of the items 103.

Referring to FIGS. 1-4, the electromagnetic conveyor system 102 includes stationary tiles 104 or planar motors 106, having multiple energized drive coils 107. In an implementation, the planar motors 106 are represented as squares or flyways 116 in FIG. 1. Such energized tiles 104 include the type in a conventional planar motor assembly, such as the system provided by Planar Motor, Inc. of Richmond, B.C., Canada. Planar Motor owns several patents directed to planar motor assemblies, including U.S. Pat. No. 10,926,418, the entire disclosure of which, except for any definitions, disclaimers, disavowals, and inconsistencies, is incorporated herein by reference. Certain systems and methods for object processing using levitation involve applicant's use of planar motor assemblies, including U.S. patent application Ser. No. 18/364,449, filed Aug. 2, 2023, and titled Systems and Methods for Object Processing Using Levitation, the entire disclosure of which, except for any definitions, disclaimers, disavowals, and inconsistences, is incorporated herein by reference.

The system 100 uses the stationary flyways 116 in conjunction with movers or carriers 108 that have directional permanent magnets. Referring to FIGS. 1-3, the tiles 104 are part of a module, and a plurality of modules can be arranged in an adjacent relationship to each other, creating a worktable 118. The modular aspect of the tiles 104 allow the user to design a variety of configurations of the worktable 118 beyond the overall rectangular arrangement shown in FIGS. 1-3. For example, a user could create an L-shaped worktable 118 to conform to an existing arrangement of other food processing equipment in a facility, or to conform to the limited space available in an existing food processing facility. The worktable 118 is where the carriers 108 adapted to support items 103 are moved under computer control to allow operators 124 at processing locations at the periphery of the worktable 118 to load carries 108 for weighing and assembling items 103 into groupings, for example, to create populations of food parts 120 for presentment to operators 124 for processing, sorting, batching, and loading.

Referring to FIG. 1, an implementation of the system 100 is shown whereby the planar motors 106 are arranged into a rectangular worktable 118 in a three by five arrangement, with incoming food parts 120 on carriers 108 at the first location 112 staged for transport to a processing location, such as a trimming station 170 manned by an operator 124. The carriers 108 then transfer the food parts 120 or components of the food parts from the processing location 170, to a conveyor location, such as a trim conveyor 172, a first product conveyor 174, a second product conveyor 176, or a third product conveyor 178. The carriers 108 are generally rectangular in shape, and can be square or elongated in shape. The food parts 120 may have differing characteristics, and the system 100 distributes the food parts 120 to the appropriate processing destination. The food parts 120 can be separated into components of food parts or constituent parts 121, such as trimmings for consumer consumption or trimmings for pet food.

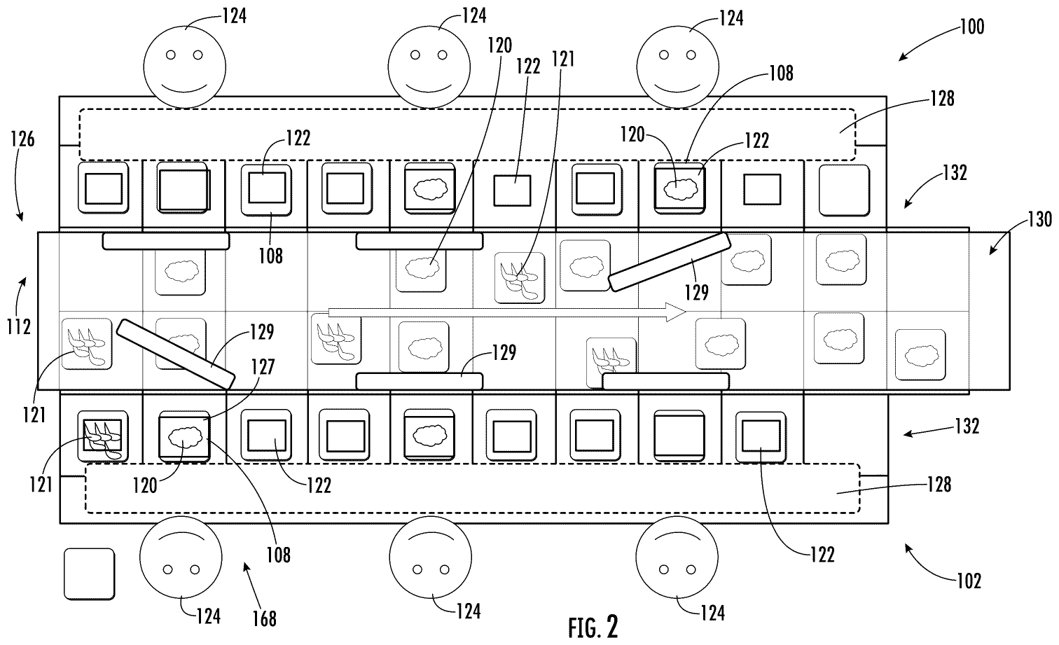

Referring to FIG. 2, an implementation of the system 100 is shown whereby the operators 124 are arranged at the periphery of a worktable 118 for performing manual trimming of the food parts 120. The carriers 108 can be adapted to receive food packaging trays 122 on their upper surface for retaining food parts 120, such as components of food parts 120 or constituent parts 121, or batches of such food parts 120, during the processing. In an implementation the tray 122 is an upwardly open container with a rectangular bottom wall, and four sidewalls extending upward from the bottom wall. In such an implementation, operators 124 at the periphery of a worktable 118 place food parts 120 or components or constituent parts 121 on the tray 122, and operators 124 remove the items or batches from the tray 122. In an implementation, the tray 122 has three sidewalls used for automatic unloading of the trays, whereby an operator 124 places a piece 120 or a batch on the tray 122, and the tray 122 is maneuvered whereby a rapid deceleration of the carrier 108 causes the contents of the tray 122 to be ejected from the open side of the three-sided tray 122, alleviating the need for an operator 124 to manually unload the tray 122 for a packing or a bagging step. The trays 122 can be adapted to quickly attach and disconnect from the carrier 108 to simplify cleaning of the system 100.

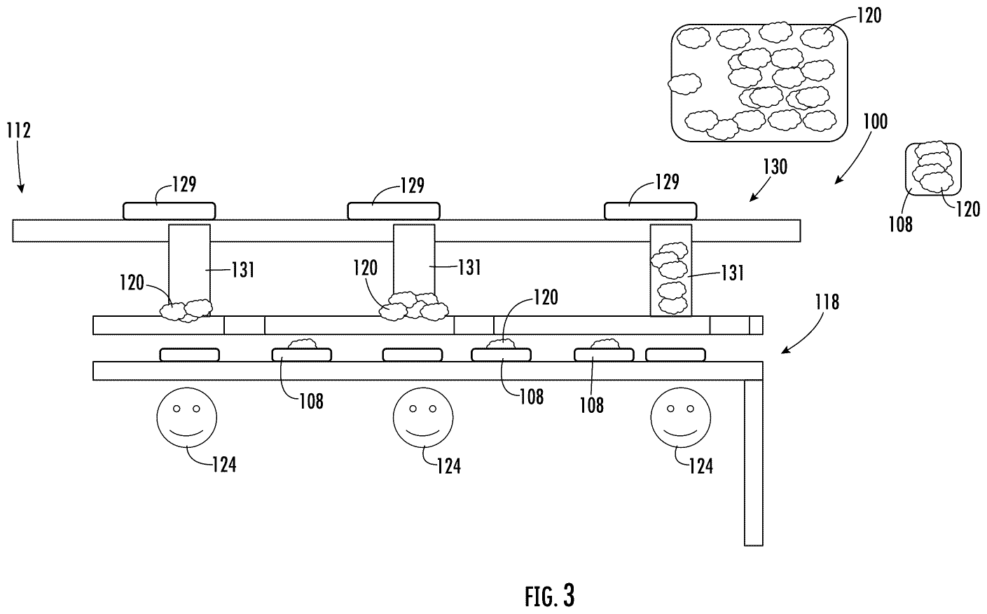

Referring to FIGS. 2-3, an implementation of a system and method involving poultry processing using the system 100 includes a plurality of flyways 116 with carriers 108 of various sizes thereabout, moving pieces of food parts 120 and components of food parts 120 or constituent parts 121, such as trimmings of food parts 120 about a trimming station. Referring to FIG. 2, individual food parts 120 or batches of food parts 120 enter the worktable 118 at a batch infeed location 126 and are dispatched to an operator 124. The infeed of food parts 120 to the worktable 118 can be accomplished by automatic, semi-automatic, or manual methods, such as a conveyor 130 disposed above the worktable 118, and controlled by the carrier distribution computer 148. The food parts 120 are transferred from the conveyor 130 to carriers 108 by a transfer mechanism, such as using distribution arms 129 or a blast of air, controlled by the carrier distribution computer 148. In an implementation, the food parts 120 are transferred from the conveyor 130 to a hopper or buffer 131 in proximity to an operator 124 prior to being deposited on a carrier 108. In an implementation, the buffer 131 is controlled by the carrier distribution computer 148 and accumulates food parts 120 transferred from the conveyor 130. The buffer 131 deposits the accumulated food parts 120 to the carrier 108 thereby depositing a batch of food parts 120. Batches or individual pieces are weighed and moved by the resulting carrier 108 about the worktable 118 to an operator 124, such as a first operator or trimmer positioned adjacent the work surface 128. The first operator removes the food part 120, piece or batch from the carrier 108 and places it on their work surface 128. The desired cutting/trimming operations are performed on the food parts 120 by the operator 124, generating constituent food parts 121 in the form of trimmings, and the trimmed pieces are placed on a designated carrier 108 on the worktable 118 for transport. Designated carriers 108 can be designated/identified for operators 124 by carrier 108 color, size, position, or any combination thereof. For example, in an implementation, carriers with blue markings can be designated for un-processed food parts 121, carriers with purple markings can be designated for a product A and delivered to the first product conveyor 174, carriers with yellow markings can be designated for a product B and be delivered to the second product conveyor 176, carriers with green markings can be designated for a product C and delivered to the third product conveyor 178, and carriers with red markings can be designated for trimmings and delivered to the trim conveyor 172. An operator 124 can be presented with a carrier 108 containing food part 120 and empty carriers 108 designed for products A, B, C, and trimmings. The operator 124 can perform tasks on the food part 120 creating trimmings and products A, B, and C and load the relevant empty carrier 108 designated for each. Depending upon the particular food processing operation being conducted, the operator 124 can be presented with several different empty carriers. Each designated carrier 108 weighs its contents/cargo and delivers the contents to the desired final location, such as conveyors located adjacent the worktable 118. The system 100 can capture identifying information of the operator 124, time, and other data for each food part 120, piece, trimmings, or batch trimmed. This data can be used to calculate performance metrics such as percentage yield, speed, and efficiency of operators 124 and/or products. The trimming station is further described as shown in FIG. 3.

In an implementation, the system 100 is used to combine pieces and batches of various food parts 120 or constituent food parts 121 into an assembly of food parts 120 in a container for consumption by a consumer. For example, the system 100 can combine a desired food part 120 quantity and total weight that is delivered to a designated operator 124 for packing for consumption, such as one poultry drumstick, and one poultry thigh, with a combined weight of 400 grams. The worktable 118 can be designated as having various zones in front of operators 124, where specific zones are designated for loading a specific food part 120 type into a specific location in the container. The carriers 108 for each food part 120 type can be designated/identified by carrier 108 color, size, position, or any combination thereof.

In an implementation, the system controls movement of the carriers 108 until a condition is met. For example, a carrier 108 can remain stationary until it senses a significant weight change due to the addition or removal of food parts 120 or constituent food parts 121. A large weight, such as by an operator 124 pressing a carrier 108 downward toward the worktable 118, can be a signal to the system 100 that the piece or batch association with that carrier 108 is defective, or has some other designated attribute. In addition, carriers 108 are moved to quadrants on each flyway 116 for weighing accuracy by limiting two carriers 108 to a flyway 116, instead of permitting carriers 108 to be positioned side-by-side.

In an implementation, the carriers 108 pass under a vision camera or other sensor to detect the food part 120 a constituent food part 121, type, color, or other important attribute for sorting or identification of the food parts during processing.

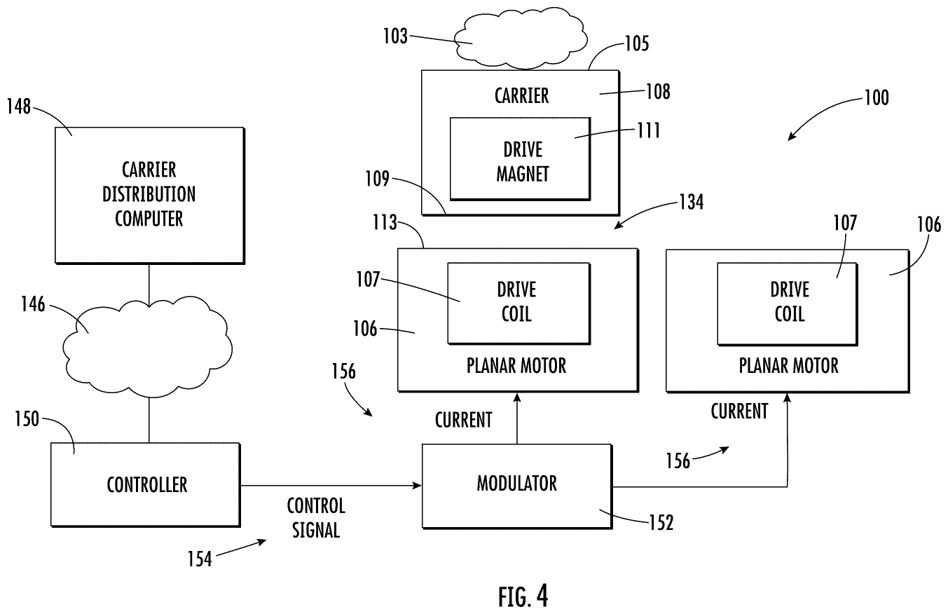

Referring to FIG. 4, the electromagnetic conveyor system 102 includes a plurality of adjacent planar motors 106 with drive coils 107 arranged adjacent to each other in a configuration about which a plurality of carriers 108 are moved under computer control. In an implementation, the carriers 108 are generally rectangular in shape, with a top surface 105 for receiving and supporting items 103, and an opposing bottom surface 109. The carriers 108 include drive magnets 111, and the drive coils 107 produce magnetic fields that interact with the drive magnets 111. In an implementation the planar motors 106 are connected to modulators 152 that control electric current 156 provided to the drive coils 176. A controller 150 delivers control signals 154 to the modulators 152 to control current 156 provided to the drive coils 107, thereby creating modulating magnetic fields that interact with the drive magnets 111 of the carriers 108 to controllably move the carriers 108 independently relative to planar motors 106. Computer control of the system 100 may be by way of a carrier distribution computer 148. The carrier distribution computer 148 has circuitry connected to memory. In an implementation, the memory is a non-transitory computer-readable storage medium in which computer-readable instructions are stored for operation and control of the planar motors 106, conveyor 130, arm 129, and buffer 131, and for controlling the location and position of the carriers 108, determining and calculating the weight of the carrier 108 and the item 103 or items on the supported by the carrier and resulting instructions, for determining and calculating displacement of the carrier 108 and resulting instructions, and instructions for movement and operation of the above. The circuitry may be dedicated circuitry or a general-purpose processor. In an implementation, the carrier distribution computer 148 executes the computer-readable instructions to perform the determining, calculating, and movement of the components of the system 100. The carrier distribution computer 148, in operation, controls movement of carriers 108 about the conveyor system 102, controls movement of the conveyor 130, arms 129, and buffers 131. The carrier distribution computer 148 is constructed and configured for electrical connection and communication via at least one communications network 146 to the conveyor system 102. In an implementation, the carrier distribution computer 148 is connected to the conveyor system 102 via at least one controller 150.

The magnetic field positions the carrier 108 above the drive coil 107, separating the bottom 109 of the carriers 108 from the top 113 of the drive coil 106 to create an air gap 134. The magnetic field is used to move the carriers 108 about the configuration of an array of two or more adjacent planar motors 106. The controller 150 controls translation of carriers 108 relative to the drive coils 107 by moving along the X-axis, Y-axis, and Z-axis. The X-axis refers to forward and rearward movement across the drive coils 107 in an action called surging. The Y-axis refers to up and down or vertical movement relative to the drive coils 107 in an action called heaving. The Z-axis refers to left and right movement across the drive coils 107 in an action called swaying. The carriers 108 are also able to rotate or turn to face a different axis. Movement between the X-axis and Y-axis is called pitch. Movement between the X-axis and Z-axis is called yaw. Movement between the Z-axis and Y-axis is called roll.

The modularity of the planar motor 106 components of the system 100, and the ability to control the system 100 using computer-readable instructions, allow the system to be adapted to meet changing use conditions and use situations in the facility in which it is installed.

Having described the disclosed subject matter, what is claimed as new and desired to be secured by Letters Patent is:

1. A food processing system, comprising:
a plurality of planar motors forming a worktable, wherein the planar motors produce magnetic fields, and wherein the worktable forms a first location and a second location;
a carrier disposed above the planar motors, wherein the carrier includes one or more magnets that interact with the magnetic fields, and wherein the magnetic fields are modulated to independently move the carrier relative to the planar motors;
wherein the carrier is adapted to support a food part; and
wherein the carrier supporting the food part is moved by the planar motors from the first location to the second location, and whereby the food part is cut to form constituent food parts.

2. The processing system of claim 1, comprising:
wherein a carrier distribution computer determines a weight value of the food part supported by the carrier.

3. The processing system of claim 1, further comprising:
wherein the worktable forms a conveyor location;
wherein a carrier is adapted to support constituent food parts; and
wherein the carrier supporting the constituent food parts is moved by the planar motors from the second location to the conveyor location.

4. The processing system of claim 1, comprising:
wherein the weight of the food part is associated with the carrier.

5. The processing system of claim 3, comprising:
wherein the weight of the constituent food parts is associated with the carrier.

6. A food processing system, comprising:
a plurality of planar motors forming a worktable, wherein the planar motors produce magnetic fields, and wherein the worktable forms a first location and a second location;
a carrier disposed above the planar motors, wherein the carrier includes one or more magnets that interact with the magnetic fields, and wherein the magnetic fields are modulated to independently move the carrier relative to the planar motors;
wherein the carrier is adapted to support a food part;
a conveyor disposed above the worktable, wherein the conveyor is adapted to transport a food part; and
a transfer mechanism adapted to transfer the food part from the conveyor to the carrier.

7. The processing system of 6, comprising:
a hopper for accumulating food parts transferred from the conveyor.

8. The processing system of 7, comprising:
wherein the hopper transfers food parts to the carrier.

9. The processing system of 6, comprising:
wherein the worktable forms a processing location; and
wherein the carrier supporting the food part is moved by the planar motor to the processing location.

10. The processing system of 9, comprising:
wherein the worktable forms a transfer zone;
wherein the carrier is adapted to support a constituent food part; and
wherein the carrier supporting the constituent food part is moved by the planar motors from the processing location to the transfer zone.

11. The processing system of 6, comprising:
wherein the food part is cut to form constituent food parts.

12. The processing system of 6, comprising:
wherein the weight of the constituent food parts is associated with the carrier.

13. The processing system of claim 6, comprising:
wherein a carrier distribution computer determines a weight value of the food part supported by the carrier.

14. The processing system of claim 6, wherein the weight of the food part is associated with the carrier.

15. A method of food processing, comprising:
providing a plurality of planar motors forming a worktable;
wherein the worktable forms a first location and a second location;
wherein the planar motors produce magnetic fields;
providing a carrier adapted to support a food part, wherein the carrier includes one or more magnets that interact with the magnetic fields produced by the planar motors, and wherein the magnetic fields are modulated by a carrier distribution computer to independently move the carrier relative to the planar motors;
providing a food part, wherein the food part is supported by the carrier; and
moving the carrier from the first location to the second location, and wherein the food part is cut to form constitute food parts at the second location.

16. The method of food processing of claim 15, comprising:
a non-transitory computer-readable storage medium stored therein computer-readable instructions, the computer-readable instruction when executed configured to:
modulate the magnetic fields; and
move the carrier from the first location to the second location.

17. The method of food processing of claim 15, comprising:
determining a weight value of the food part supported by the carrier.

18. The method of food processing of claim 17, comprising:
a non-transitory computer-readable storage medium stored therein computer-readable instructions, the computer-readable instruction when executed configured to determine the weight value of the food part supported by the carrier.

19. The method of food processing of claim 18, comprising:
associate the weight value of the food part with the carrier.
